(19) United States
(12) Patent Application Publication
(10) Pub. No.: US 2024/0132716 A1
(43) Pub. Date: Apr. 25, 2024

(54) BIODEGRADABLE CONTAINER CLOSURE AND RESIN THEREFOR

(71) Applicant: Danimer IPCo, LLC, Bainbridge, GA (US)

(72) Inventors: Adam Johnson, Bainbridge, GA (US); Eric McClanahan, Athens, GA (US); Karson Durie, Athens, GA (US)

(73) Assignee: Danimer IPCo, LLC, Bainbridge, GA (US)

(21) Appl. No.: 18/405,014

(22) Filed: Jan. 5, 2024

Related U.S. Application Data
(62) Division of application No. 17/482,758, filed on Sep. 23, 2021.
(60) Provisional application No. 63/082,558, filed on Sep. 24, 2020.

(51) Int. Cl. C08L 67/04; B65D 65/46; C08G 63/06; C08K 5/00

(52) U.S. Cl. CPC C08L 67/04; B65D 65/466; C08G 63/06; C08K 5/0083; C08L 2201/06

(57) ABSTRACT

A biodegradable container closure and a method for making the container closure. The biodegradable container closure includes from about 40 to about 99 weight percent of a polymer derived from random monomeric repeating units having a structure of

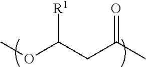

wherein R¹ is selected from the group consisting of CH₃ and a C₃ to C₁₉ alkyl group. The monomeric units having R¹═CH₃ is about 75 to about 99 mol percent of the polymer. A resin adapted for forming the closure is also disclosed.

### TECHNICAL FIELD

The disclosure is directed to biodegradable containers and closures therefor and in particular to compositions and methods for making biodegradable container closures.

### BACKGROUND AND SUMMARY

With the current plastics crisis, plastics are being continuously replaced with bio-friendly alternatives. One large contributor to the plastic problem is poly(ethylene terephthalate) (PET) water bottles. It is estimated that in 2017 one million PET water bottles were sold every minute. Considering that it takes ˜450 years for a PET bottle to completely degrade, the earth is becoming over-polluted with PET bottles. Furthermore, while PET can be recycled, some developed countries, such as the US, only recycle a fraction of the PET bottles used, and other less-developed countries do not have a recycling stream at all. In these countries with no recycling infrastructure, the PET bottles often end up in the ocean, breaking down into microplastics that begin to damage the ecosystem as the marine life consume them, mistaking them for food.

Each part of the bottle plays a role in this issue, including the bottle, label, and closure. On PET bottles, closures are typically made from polyolefins, such as poly(propylene) or poly(ethylene). Polyolefin closures are typically made via injection molding, and the processing conditions for these materials have been optimized over the years, maximizing productivity and costs. However, these materials are petroleum-based and take hundreds of years to degrade.

To mitigate the environmental issues associated with conventional closure materials, closures may be made from biomaterials. Closures have been successfully made from biomaterials, such as using poly(lactic acid), but often, these materials do not degrade in a significant amount of time and require external stimuli, such as heat and pressure, to degrade to the desired extent.

Additionally, if other biomaterials are able to be molded into bottle closures, the biopolymers typically have dismal barrier properties, such as bottles and closures made from poly(lactic acid).

In view of the foregoing, poly(hydroxyalkanoate) (PHA) container closures are provided that are highly biodegradable. The PHA container closures are made by modifying PHA with other polymers, fillers, and additives and then injection molding the polymer formulations into closures. Because of the brittle nature of PHA, additional materials are necessary to be added to the PHA formulation in order to preserve the features of the closures during ejection from the mold.

In some embodiments, the disclosure provides a biodegradable container closure. The biodegradable container closure includes from about 40 to about 99 weight percent of a polymer derived from random monomeric repeating units having a structure of

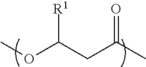

wherein R¹ is selected from the group consisting of CH₃ and/or a C₃ to C₁₉ alkyl group. The monomeric units having R¹═CH₃ is about 75 to about 99 mol percent of the polymer.

The body of the closure also typically includes from about 0.1 to about 10 weight percent of at least one nucleating agent.

In some embodiments, the biodegradable container closure includes from about 40 to about 99 weight percent of poly(hydroxyalkanoate) copolymer and from about 1 to about 60 wt. % additional additives.

In some embodiments, the biodegradable container closure includes polyhydroxybutyrate as the poly(hydroxyalkanoate).

In other embodiments, the biodegradable container closure includes poly-3-hydroxybutyrate-co-3-hydroxyhexanoate (P3HB-co-P3HHx) as the poly(hydroxyalkanoate).

In some embodiments, the container closure further includes from about 1.0 to about 15.0 weight percent of at least one poly(hydroxyalkanoate) containing from about 25 to about 50 mole percent of a poly(hydroxyalkanoate) selected from poly(hydroxyhexanoate), poly(hydroxyoctanoate), poly(hydroxydecanoate), and mixtures thereof.

In some embodiments, the biodegradable container closure may further include poly(hydroxyalkanoate)s including a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from poly(hydroxyhexanoate), poly(hydroxyoctanoate), poly(hydroxydecanoate), and mixtures thereof.

In other embodiments, the poly(hydroxyalkanoate) polymer has a weight average molecular weight ranging from about 50 thousand Daltons to about 2.5 million Daltons.

In some embodiments, the poly(hydroxyalkanoate) polymer includes from about 0.1 weight percent to about 3 weight percent of at least one nucleating agent selected from erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

In some embodiments, the poly(hydroxyalkanoate) polymer further includes from about 1 weight percent to about 40 weight percent of at least one filler chosen from calcium carbonate, talc, starch, zinc oxide, neutral alumina, and mixtures thereof.

In some embodiments, the container closure further includes from about 1 weight percent to about 50 weight percent of polymers selected from poly(lactic acid), poly(caprolactone), poly(ethylene sebicate), poly(butylene succinate), and poly(butylene succinate-co-adipate), and copolymers and blends thereof.

In other embodiments, the container closure further includes from about 0.1 weight percent to about 3 weight percent of a fatty acid amide slip agent.

In some embodiments, the container closure has a moisture vapor transmission rate of about 20 g/m²/day or less as measured under ASTM E96.

In other embodiments, there is provided a method for making a biodegradable container closure from a poly(hydroxyalkanoate) polymer that includes forming the container closure in a process selected from injection molding and compression molding.

According to certain embodiments, the container closure also includes from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.

In another aspect, the disclosure also provides a resin which is adapted for forming the biodegradable container closure described above. The resin is made up of poly(hydroxyalkanoate) and optionally other polymers, as well as other additives as described above with respect to the biodegradable container closure.

### DETAILED DESCRIPTION

The present invention answers the need for a biodegradable container having a biodegradable container closure using biodegradable materials that are capable of being easily processed into plastic container closures. The biodegradable materials and container closures made therefrom answer a need for disposable containers having increased biodegradability and/or compostability.

As used herein, “ASTM” means American Society for Testing and Materials.

As used herein, “alkyl” means a saturated carbon-containing chain which may be straight or branched; and substituted (mono- or poly-) or unsubstituted.

As used herein, “alkenyl” means a carbon-containing chain which may be monounsaturated (i.e., one double bond in the chain) or polyunsaturated (i.e., two or more double bonds in the chain); straight or branched; and substituted (mono- or poly-) or unsubstituted.

As used herein, “PHA” means a poly(hydroxyalkanoate) as described herein having random monomeric repeating units of the formula

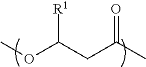

wherein R¹ is selected from the group consisting of CH₃ and a C₃ to C₁₉ alkyl group. The monomeric units wherein R¹ is CH₃ are about 75 to about 99 mol percent of the polymer.

As used herein, “P3HB” means the poly-(3-hydroxybutyrate).

As used herein, “P3HHx” means the poly(3-hydroxyhexanoate)

As used herein, “biodegradable” means the ability of a compound to ultimately be degraded completely into CO₂ and water or biomass by microorganisms and/or natural environmental factors, according to ASTM D5511 (anaerobic and aerobic environments), ASTM 5988 (soil environments), ASTM D5271 (freshwater environments), or ASTM D6691 (marine environments). Biodegradability may also be determined using ASTM D6868 and European EN 13432.

As used herein, “compostable” means a material that meets the following three requirements: (1) the material is capable of being processed in a composting facility for solid waste; (2) if so processed, the material will end up in the final compost; and (3) if the compost is used in the soil, the material will ultimately biodegrade in the soil according to ASTM D6400 for industrial and home compostability.

Unless otherwise noted, all molecular weights referenced herein are weight average molecular weights, as determined in accordance with ASTM D5296.

All copolymer composition ratios recited herein refer to mole ratios, unless specifically indicated otherwise.

In one embodiment of the present invention, at least about 50 mol %, but less than 100%, of the monomeric repeating units have CH₃ as R¹, more preferably at least about 60 mol %; more preferably at least about 70 mol %; more preferably at least about 75 to 99 mol %.

In another embodiment, a minor portion of the monomeric repeating units have R¹ selected from alkyl groups containing from 3 to 19 carbon atoms. Accordingly, the copolymer may contain from about 0 to about 30 mol %, preferably from about 1 to about 25 mol %, and more particularly from about 2 to about 10 mol % of monomeric repeating units containing a C₃ to C₁₉ alkyl group as R¹.

In some embodiments, a preferred PHA copolymer for use with the present disclosure is poly-3-hydroxybutyrate-co-3-hydroxyhexanoate (P3HB-co-P3HHx). In certain embodiments, this PHA copolymer preferably comprises from about 94 to about 98 mole percent repeat units of 3-hydroxybutyrate and from about 2 to about 6 mole percent repeat units of 3-hydroxyhexanoate.

### Synthesis of Biodegradable PHAs

Biological synthesis of the biodegradable PHAs useful in the present invention may be carried out by fermentation with the proper organism (natural or genetically engineered) with the proper feedstock (single or multicomponent). Biological synthesis may also be carried out with bacterial species genetically engineered to express the copolymers of interest (see U.S. Pat. No. 5,650,555, incorporated herein by reference).

### Crystallinity

The volume percent crystallinity (Φ_{c}) of a semi-crystalline polymer (or copolymer) often determines what type of end-use properties the polymer possesses. For example, highly (greater than 50%) crystalline polyethylene polymers are strong and stiff, and suitable for products such as plastic milk containers. Low crystalline polyethylene, on the other hand, is flexible and tough, and is suitable for products such as food wraps and garbage bags. Crystallinity can be determined in a number of ways, including x-ray diffraction, differential scanning calorimetry (DSC), density measurements, and infrared absorption. The most suitable method depends upon the material being tested.

The volume percent crystallinity (Φc) of the PHA copolymer may vary depending on the mol percentage of P3HHx in the PHA copolymer. The addition of P3HHx effectively lowers the volume percent crystallinity of the PHA copolymer, crystallization rate, and melting temperature while providing an increase in the flexibility and degradability of the copolymer. Nucleating agents, as described herein may be used to speed up the crystallization process of the PHA copolymers.

In general, PHAs of the present invention preferably have a crystallinity of from about 0.1% to about 99% as measured via x-ray diffraction; more preferably from about 2% to about 80%; more preferably still from about 20% to about 70%.

When a PHA of the present invention is to be processed into a molded article, the amount of crystallinity in such PHA is more preferably from about 10% to about 80% as measured via x-ray diffraction; more preferably from about 20% to about 70%; more preferably still from about 30% to about 60%.

### Melt Temperature

Preferably, the biodegradable PHAs of the present invention have a melt temperature (Tₘ) of from about 30° C. to about 170° C., more preferably from about 90° C. to about 165° C., more preferably still from about 130° C. to about 160° C.

### Molded Articles

According to the disclosure, a polymeric container closure is formed from a resin comprising a polymer or copolymer materials (e.g., PHA) which are injection or compression molded. In particular the molded articles may be plastic screw-type and snap-on bottle closures for bottles that hold carbonated and non-carbonated liquids, as well as dry materials including, but not limited to powders, pellets, capsules, and the like.

Injection molding of thermoplastics is a multi-step process by which a PHA formulation of the present invention is heated until it is molten, then forced into a closed mold where it is shaped, and finally solidified by cooling.

Compression molding in thermoplastics consists of charging a quantity of a composition as described herein into the lower half of an open die. The top and bottom halves of the die are brought together under pressure, and then the molten composition conforms to the shape of the die. The mold is then cooled to a harden the material.

The cycle time is defined herein as holding time plus cooling time. With process conditions substantially optimized for a particular mold, a cycle time is a function of copolymer blend composition. Process conditions substantially optimized are the temperature settings of the barrel, nozzle, and mold of the molding apparatus, the shot size, the injection pressure, and the hold pressure. Cycle times provided herein for a PHA copolymer blended with an environmentally degradable polymer are at least ten seconds shorter than such times for a PHA copolymer absent the blend.

Shrinkage during molding is taken into account through the mold design. Shrinkage of about 1.5% to 5%, from about 1.0% to 2.5%, or 1.2% to 2.0% may occur.

Processing temperatures that are set low enough to avoid thermal degradation of the polymer blend material, yet high enough to allow free flow of the material for molding are used. The PHA copolymer blends are melt processed at melting temperatures less than about 180° C. or, more typically, less than about 160° C. to minimize thermal degradation. In general, polymers can thermally degrade when exposed to temperatures above the degradation temperature after melt for a period of time. As is understood by those skilled in the art in light of the present disclosure, the particular time required to cause thermal degradation will depend upon the particular material, the length of time above the melt temperature (Tₘ), and the number of degrees above the Tₘ. The temperatures can be as low as reasonably possible to allow free-flow of the polymer melt in order to minimize risk of thermal degradation. During extrusion, high shear in the extruder increases the temperature in the extruder higher than the set temperature. Therefore, the set temperatures may be lower than the melt temperature of the material.

PHA containers and closures for the containers are made by modifying PHA with melt strength enhancers, chain extenders, and other processing aids. The formulations according to the disclosure may contain from about 40 to 99 weight percent of poly(hydroxyalkanoate) copolymer and from about 1 to about 60 wt. % polymer modifiers. In some embodiments, the poly(hydroxyalkanoate) copolymer is poly-3-hydroxybutyrate-co-3-hydroxyhexanoate (P3HB-co-P3HHx). In other embodiments, the PHA composition includes from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

In some embodiments, the PHA formulation used to make biodegradable container closures may include from about 0.5 weight percent to about 15 weight percent of at least one plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, polyethylene glycols having a number average molecular weight of 400-10,000 g/mol, esters of vegetable oils, long chain alkyl acids, adipates, glycerol, isosorbide derivatives or mixtures thereof.

In other embodiments, the PHA formulation preferably also includes from about 0.1 weight percent to about 10 weight percent, or from about 0.1 to about 20 weight percent, of at least one nucleating agent selected from sulfur, erythritols, pentaerythritol, dipentaerythritols, inositols, stearates, sorbitols, mannitols, polyester waxes, compounds having a 2:1; 2:1 crystal structure chemicals, boron nitride, and mixtures thereof.

In certain preferred embodiments, the PHA formulation may include from about 0.1 to about 3 weight percent of a nucleating agent selected from boron nitride or pentaerythritol, and more preferably from about 0.3 to about 1.5 weight percent of boron nitride or pentaerythritol. Moreover, in instances in which boron nitride is used as a nucleating agent, the PHA formulation may also include from about 1 to about 5 weight percent of poly(hydroxybutyrate) homopolymer in addition to poly(hydroxyalkanoate) copolymer.

In some embodiments, the PHA formulation preferably includes from about 0 to about 1 percent by weight, such as from about 1 to about 0.5 percent by weight of a melt strength enhancer/rheology modifier. This melt strength enhancer may for instance be selected from the group consisting of a multifunctional epoxide; an epoxy-functional, styrene-acrylic polymer; an organic peroxide such as di-t-butyl peroxide; an oxazoline; a carbodiimide; and mixtures thereof.

Without being bound by theory, this additive is believed to act as a cross-linking agent to increase the melt strength of the PHA formulation. Alternatively, in some instances, the amount of the melt strength enhancer is from about 0.05 to about 3 weight percent. More preferred melt strength enhancers include organic peroxides, epoxides, and carbodiimides, preferably in an amount from about 0.05 to about 0.2 weight percent of the PHA formulation.

In some embodiments, the PHA formulation may include one or more performance enhancing polymers selected from poly(lactic acid), poly(caprolactone), poly(ethylene sebicate), poly(butylene succinate), and poly(butylene succinate-co-adipate) (PBSA), and copolymers and blends thereof. The performance enhancing polymers may be present in the formulation in a range of from about 1 to about 60 percent by weight.

In some embodiments, the polymer formulation includes a slip agent. The most common slip agents are long-chain, fatty acid amides, such as erucamide and oleamide. One or more slip agents, for example calcium stearate or fatty acid amides is/are typically included in the polymer formulation. When included in the formulation, the amount of slip agent may range from about 0.5 to about 3 percent by weight of a total weight of the polymer formulation.

Exemplary formulations that may be used to make biodegradable container closures according to the disclosure are shown in the following table.

| | PHA | PHA | | | | | | |
|---|---|---|---|---|---|---|---|---|
| | polymer | polymer | | | | | | |
| | wt. % | wt. % | | | | | | |
| | 3 mol % | 6 mol % | | | Weight % | | | |
| | Hexanoate | Hexanoate | Weight % | Weight % | Calcium | Weight % | Weight % | Weight % |
| Formula | in polymer | in polymer | PBSA | PBS | Carbonate | Pentaerythritol | Behenamide | Polylactic acid |
| 1 | — | 58.7 | 16.6 | — | 21.7 | 1.5 | 1.5 | — |
| 2 | — | 40 | — | — | 31.7 | 1.5 | 1.5 | 25.3 |
| 3 | 40 | — | — | — | 31.7 | 1.5 | 1.5 | 25.3 |
| 4 | 50 | — | 38 | — | — | 2 | — | 10 |
| 5 | 58.6 | — | 21.7 | — | 18.2 | 1.5 | — | — |

With the formulations provided, the PHA should degrade rapidly, but the degradation kinetics will depend on the design of the container closure, with thicker walled materials taking longer to fully degrade. It is preferred that the container closures undergo degradation according to TUV Austria Program OK 12, have a shelf-life of at least 24 months, and have a moisture vapor transmission rate of about 20 g/m²/day or less as determined under ASTM E96.

Two bottle closures, screw on 30/25 and PCO-1810 bottle caps, were made from two different types of molds, showing the versatility of the PHA formulation described herein for use in producing different types of closures. Additionally, though the PHA formulations were injection molded, evidence suggests that the disclosed PHA formulations are excellent candidates for production via compression molding as well. Based on the formulations presented herein, the closures should offer swift degradation rates and serve as an alternative to the poly(olefin) closures used today. The foregoing PHA-based closures are intended to be placed on PHA-based containers affixed with a PHA-based label, so that the entire container is biodegradable.

The present disclosure is also further illustrated by the following embodiments:

Embodiment 1. A biodegradable container closure comprising:
from about 0.1 to about 10 weight percent of at least one nucleating agent; and
from about 40 to about 99 weight percent of a polymer derived from random monomeric repeating units having a structure of

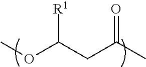

wherein R¹ is selected from the group consisting of CH₃ and a C₃ to C₁₉ alkyl group, wherein the monomeric units having R¹═CH₃ comprise 75 to 99 mol percent of the polymer.

Embodiment 2. The biodegradable container closure of Embodiment 1, wherein the container closure comprises from about 40 to about 99 weight percent of poly(hydroxyalkanoate) copolymer and from about 1 to about 60 wt. % additional additives.

Embodiment 3. The biodegradable container closure of Embodiment 2 wherein the poly(hydroxyalkanoate) copolymer comprises poly-3-hydroxybutyrate-co-3-hydroxyhexanoate (P3HB-co-P3HHx).

Embodiment 4. The biodegradable container closure of Embodiment 1, wherein the container closure further comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

Embodiment 5. The biodegradable container closure of Embodiment 1, wherein the container closure further comprises poly(hydroxyalkanoate)s comprising a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of poly(hydroxyhexanoate), poly(hydroxyoctanoate), poly(hydroxydecanoate), and mixtures thereof.

Embodiment 6. The biodegradable container closure of Embodiment 1, wherein the polymer has a weight average molecular weight ranging from about 50 thousand Daltons to about 2.5 million Daltons.

Embodiment 7. The biodegradable container closure of Embodiment 1, wherein the polymer comprises from about 0.1 weight percent to about 3 weight percent of at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

Embodiment 8. The biodegradable container closure of Embodiment 1, wherein the polymer further comprises from about 1 weight percent to about 40 weight percent of at least one filler selected from the group consisting of calcium carbonate, talc, starch, zinc oxide, neutral alumina, and a mixture thereof.

Embodiment 9. The biodegradable container closure of Embodiment 1, wherein the container closure further comprises from about 1 weight percent to about 50 weight percent of polymers selected from the group consisting of poly(lactic acid), poly(caprolactone), poly(ethylene sebicate), poly(butylene succinate), and poly(butylene succinate-co-adipate), and copolymers and blends thereof.

Embodiment 10. The biodegradable container closure of Embodiment 1, wherein the container closure further comprises from about 0.1 weight percent to about 3 weight percent of a fatty acid amide slip agent.

Embodiment 11. The biodegradable container closure of Embodiment 1, wherein the container closure has a moisture vapor transmission rate of about 20 g/m²/day or less as measured under ASTM E96.

Embodiment 12. The biodegradable container closure of Embodiment 1, wherein the biodegradable container closure undergoes degradation according to ASTM D5511 (anaerobic and aerobic environments), ASTM 5988 (soil environments), ASTM D5271 (freshwater environments), ASTM D6691 (marine environments), ASTM D6868, or ASTM D6400 for industrial and home compostability (in soil).

Embodiment 13. A method for making a biodegradable container closure from the polymer of Embodiment 1 comprising forming the container closure in a process selected from the group consisting of injection molding and compression molding.

Embodiment 14. The biodegradable container closure of Embodiment 1, wherein the container closure further comprises from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A biodegradable container closure comprising:
from about 40 to about 99 weight percent of a poly(hydroxyalkanoate) copolymer derived from random monomeric repeating units having a structure of 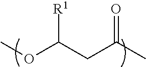
wherein R¹ is selected from the group consisting of CH₃ and a C₃ to C₁₉ alkyl group, wherein the copolymer comprises 75-99 mol % monomeric units having R¹ being CH₃ and the balance of monomeric units having R¹ being selected from C₃ to C₁₉ alkyl groups, wherein the poly(hydroxyalkanoate) copolymer comprises poly-3-hydroxybutyrate-co-3-hydroxyhexanoate (P3HB-co-P3HHx) and from about 1 to about 60 wt. % additional additives, wherein the additional additives comprise from about 0.1 to about 10 weight percent of at least one nucleating agent, and from about 0.05 to about 3 weight percent of a melt strength enhancer consisting essentially of a mixture of an organic peroxide and an oxazoline.

2. (canceled)

3. (canceled)

4. The biodegradable container closure of claim 1, wherein the biodegradable container closure further comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

5. The biodegradable container closure of claim 1, wherein the biodegradable container closure further comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyoctanoate, 3-hydroxydecanoate, and mixtures thereof.

6. The biodegradable container closure of claim 1, wherein the poly(hydroxyalkanoate) copolymer has a weight average molecular weight ranging from about 50 thousand Daltons to about 2.5 million Daltons.

7. The biodegradable container closure of claim 1, wherein the additional additives comprise from about 0.1 weight percent to about 3 weight percent of the at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

8. The biodegradable container closure of claim 1, wherein the additional additives further comprise from about 1 weight percent to about 40 weight percent of a filler selected from the group consisting of calcium carbonate, talc, starch, zinc oxide, neutral alumina, and mixtures thereof.

9. The biodegradable container closure of claim 1, wherein the biodegradable container closure further comprises from about 1 weight percent to about 50 weight percent of polymers selected from the group consisting of poly(lactic acid), poly(caprolactone), poly(ethylene sebacate), poly(butylene succinate), and poly(butylene succinate-co-adipate), and copolymers and blends thereof.

10. The biodegradable container closure of claim 1, wherein the additional additives further comprise from about 0.1 weight percent to about 3 weight percent of a fatty acid amide slip agent.

11. The biodegradable container closure of claim 1, wherein the biodegradable container closure has a moisture vapor transmission rate of about 20 g/m²/day or less as measured under ASTM E96.

12. The biodegradable container closure of claim 1, wherein the biodegradable container closure undergoes degradation according to ASTM D5511 (anaerobic and aerobic environments), ASTM 5988 (soil environments), ASTM D5271 (freshwater environments), ASTM D6691 (marine environments), ASTM D6868, or ASTM D6400 for industrial and home compostability (in soil).

13. (canceled)

14. A method for making a biodegradable container closure from the poly(hydroxyalkanoate) copolymer of claim 1, comprising forming the container closure in a process selected from the group consisting of injection molding and compression molding.
